(19) United States
(12) Patent Application Publication
(10) Pub. No.: US 2005/0222935 A1
(43) Pub. Date: Oct. 6, 2005

(54) Micro auctioning

(76) Inventor: George Tannous, Tujunga, CA (US)

Correspondence Address: AUCTIONDINER. COM ATTN,MIKE BERMAN, 401 N. BRAND BLVD SUITE #750, GLENDALE, CA, 91203, US

(21) Appl. No.: 10/774,270

(22) Filed: Feb. 6, 2004

Related U.S. Application Data
(60) Provisional application No. 60/446,414, filed on Feb. 11, 2003.

(51) Int. Cl. G06F 17/60

(52) U.S. Cl. 705/37

(57) ABSTRACT

A process for localizing online auctions and local or national businesses by zipcodes. with the steps of: Provide a national online auction site, Provide a national business advertisements web site, and Provide many localized, by zip codes, online web sites. Many domain names such as shop91042.com or shop 91011.com would be purchased nationally. All these domains would be incorporated to one or more national web sites. The national web sites would allow members to list items up for auction and will export them automatically to the local shop(any zip code).com web site. memebrs are also able to list items for auctions from the local web site and have it exported to the national web site. Same apply to the the national business advertisers such as the impoting and or exporting nationally and locally of all business listings.

### CROSS REFERENCE TO RELATED APPLICATIONS

This application is based on provisional application Ser. No. 60/446,414, filed on Feb. 11, 2003.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of online auctioning and national business advertisers and more specifically to micro Auctioning as well as micro online business advertisers via the online zip code web sites method such as shop91042.com. Online auctions have become a way of life o the world Wide Web. Today, there are many companies that offer these services such as ebay.com, yahoo.com, etc.

The prior technology of existing online auction web sites are to have members list items for sale on a national level.

The deficiency in prior tehnology is that the consideration of allowing localized, by online zip code web sites, operate in concurrent with the national web site thus allowing local residents feel at ease when selling or buying items up for auction.

### BRIEF SUMMARY OF THE INVENTION

The primary object of the invention is To provide a method for national and internationl online auction site.

Another object of the invention is To provide a method for capturing data from the national running auctions and upload them to the local zip code web site.

Another object of the invention is To provide a method so local residence and business owners within a local zip code to shop and place bids on online auctions.

A further object of the invention is To provide a method for local businesses to be listed in a localized online zip code web site.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for localizing online auctions and local or national businesses by zipcodes. comprising the steps of: Provide a national online auction site, Provide a national business advertisements web site, and Provide many localized, by zip codes, online web sites.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

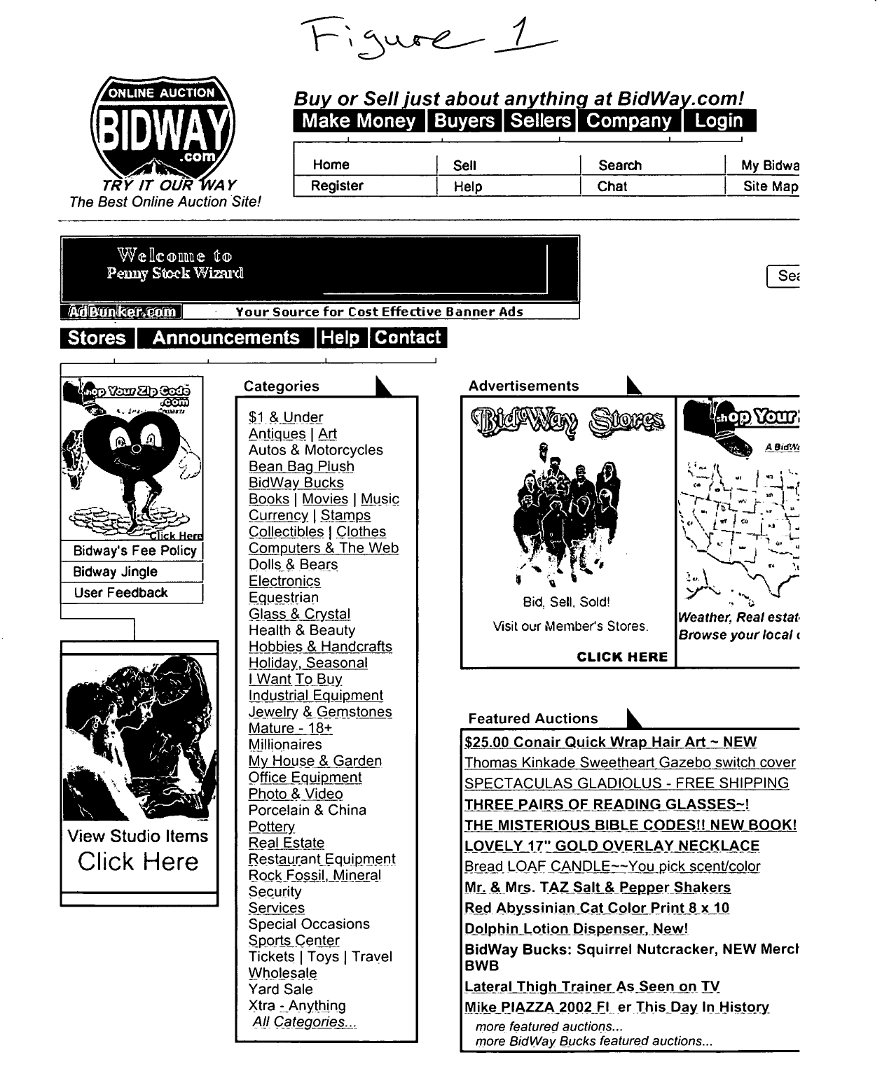

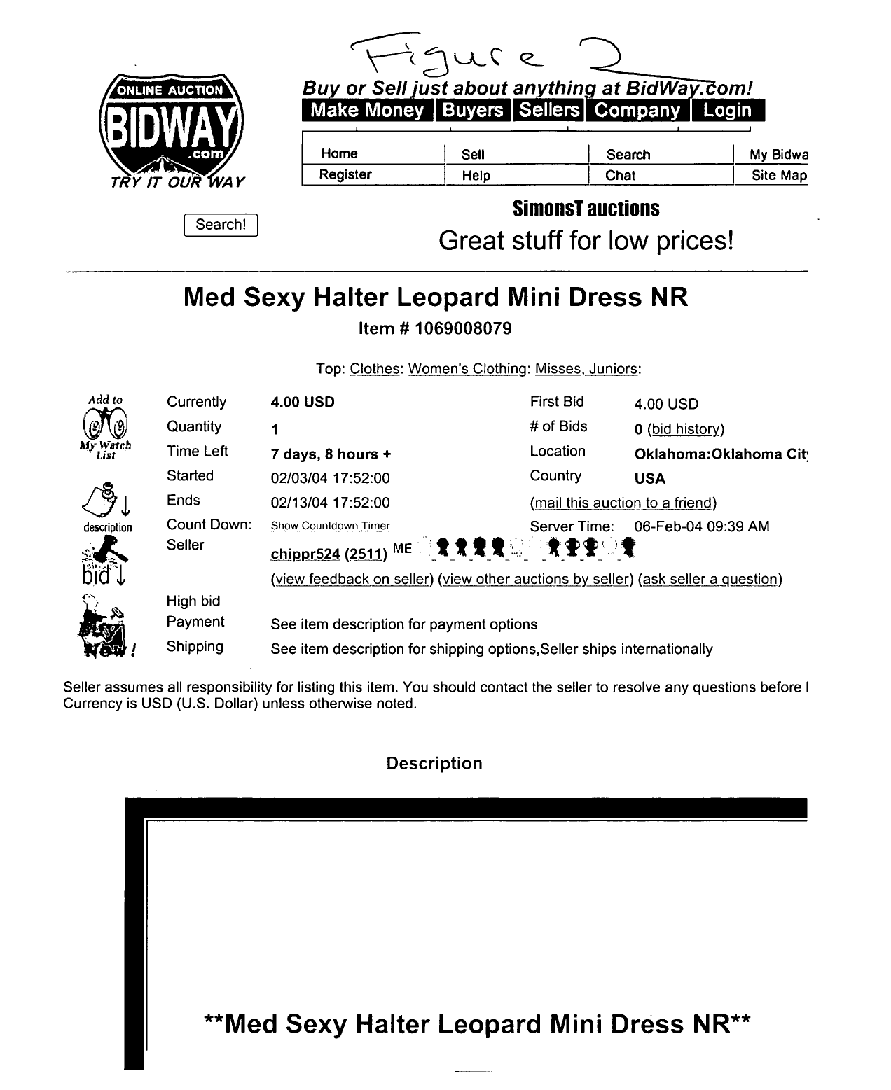

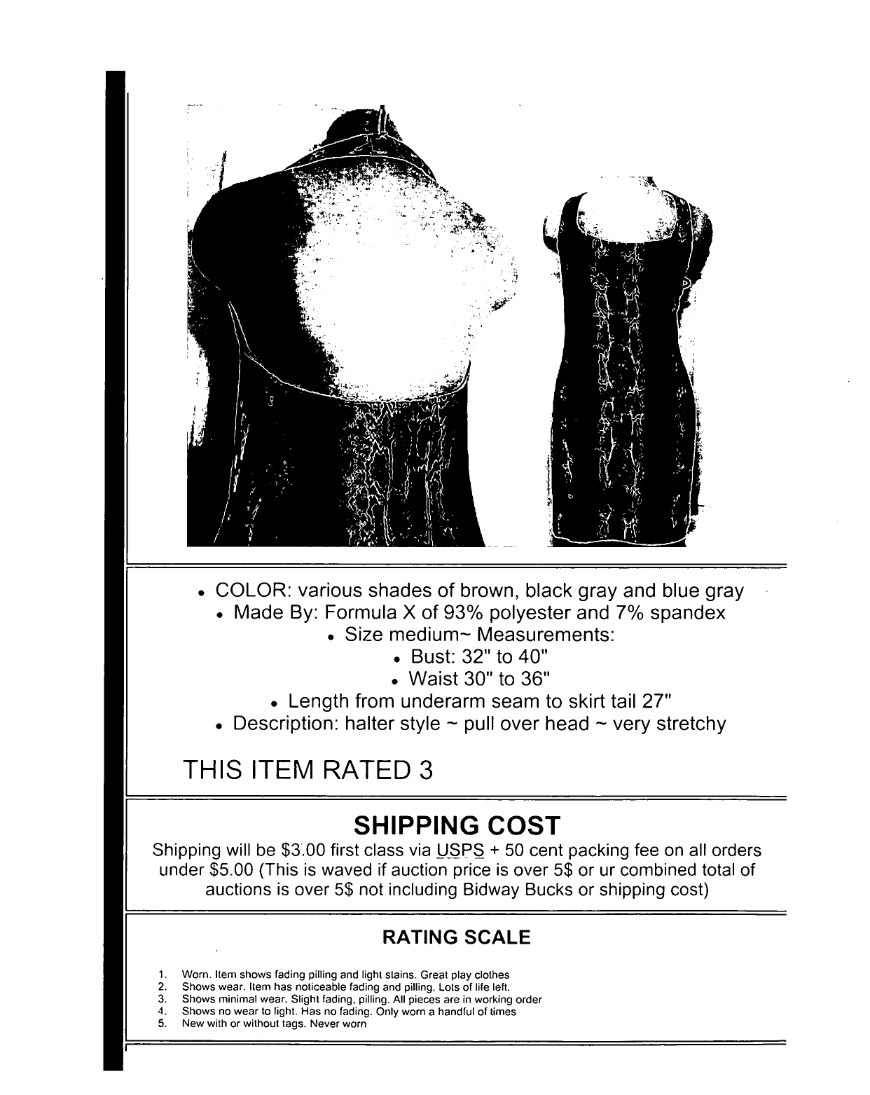

Turning first to FIG. 1, displayed is the national web site Bidway.com.

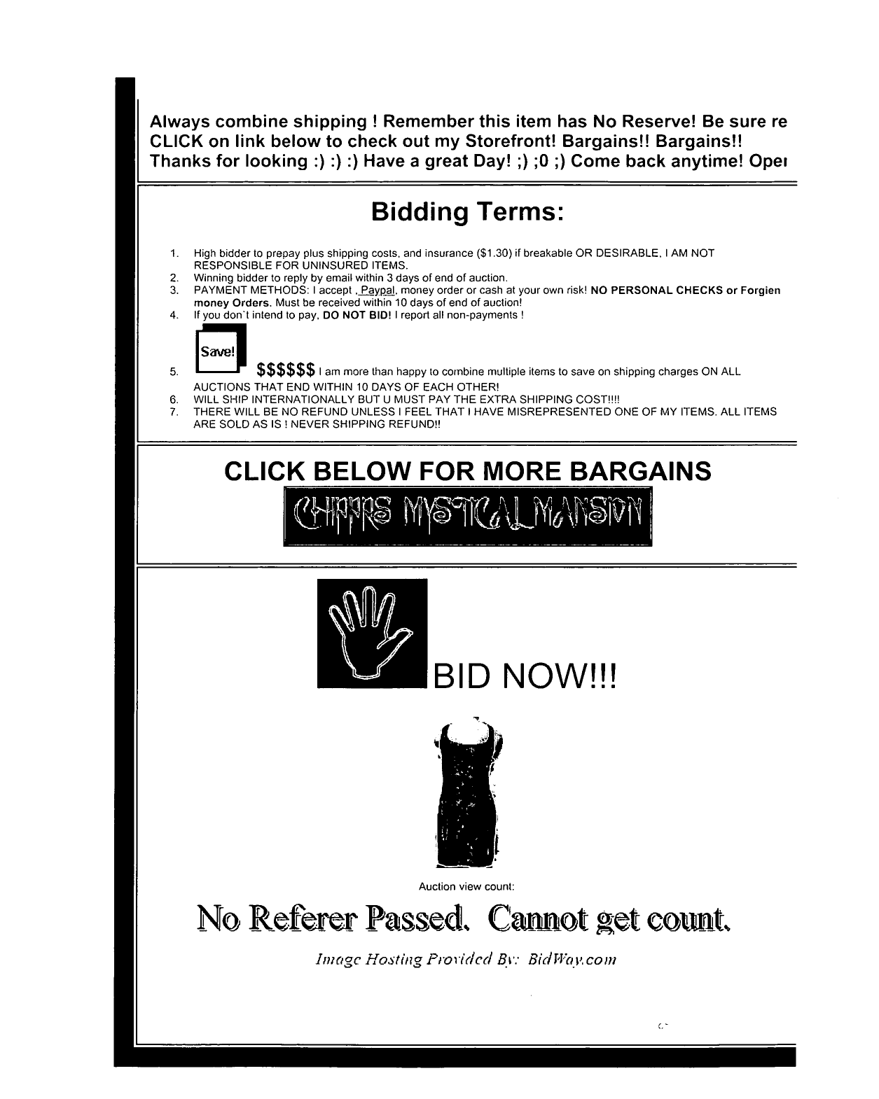

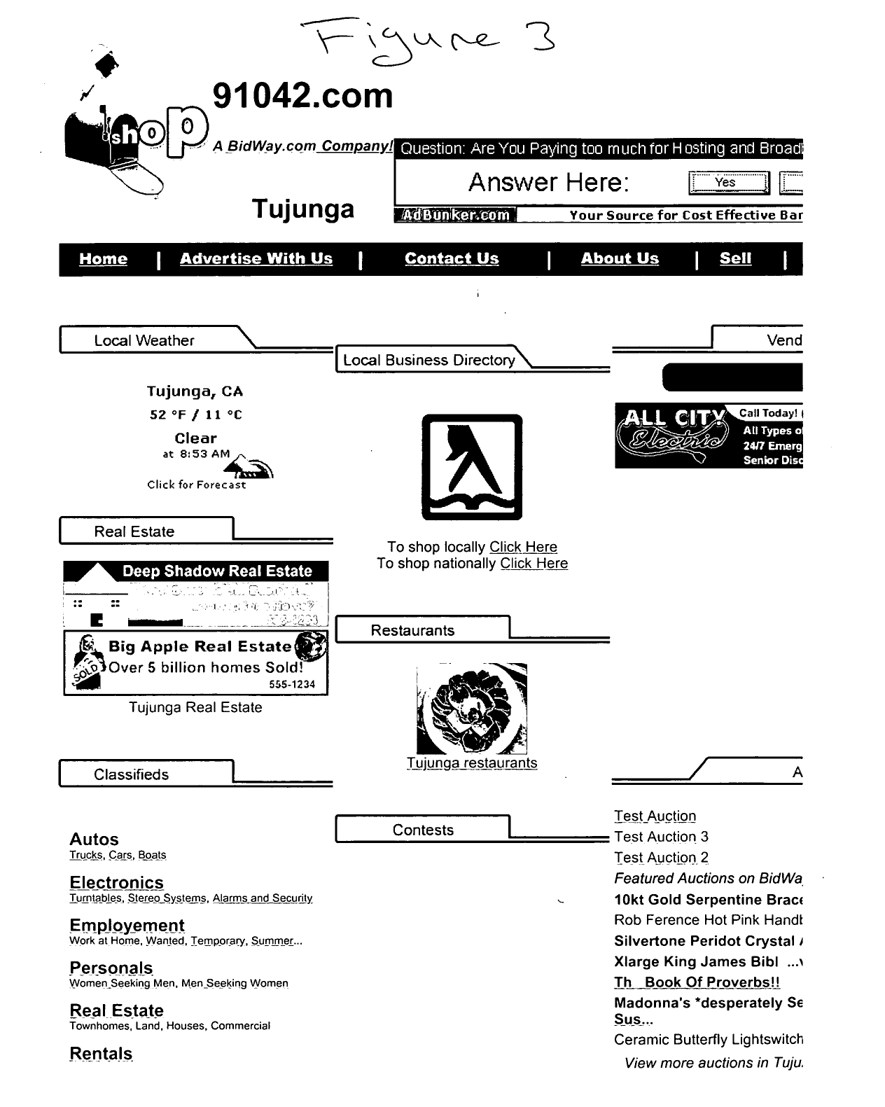

Turning second to FIG. 2 is running auction on the national web site.

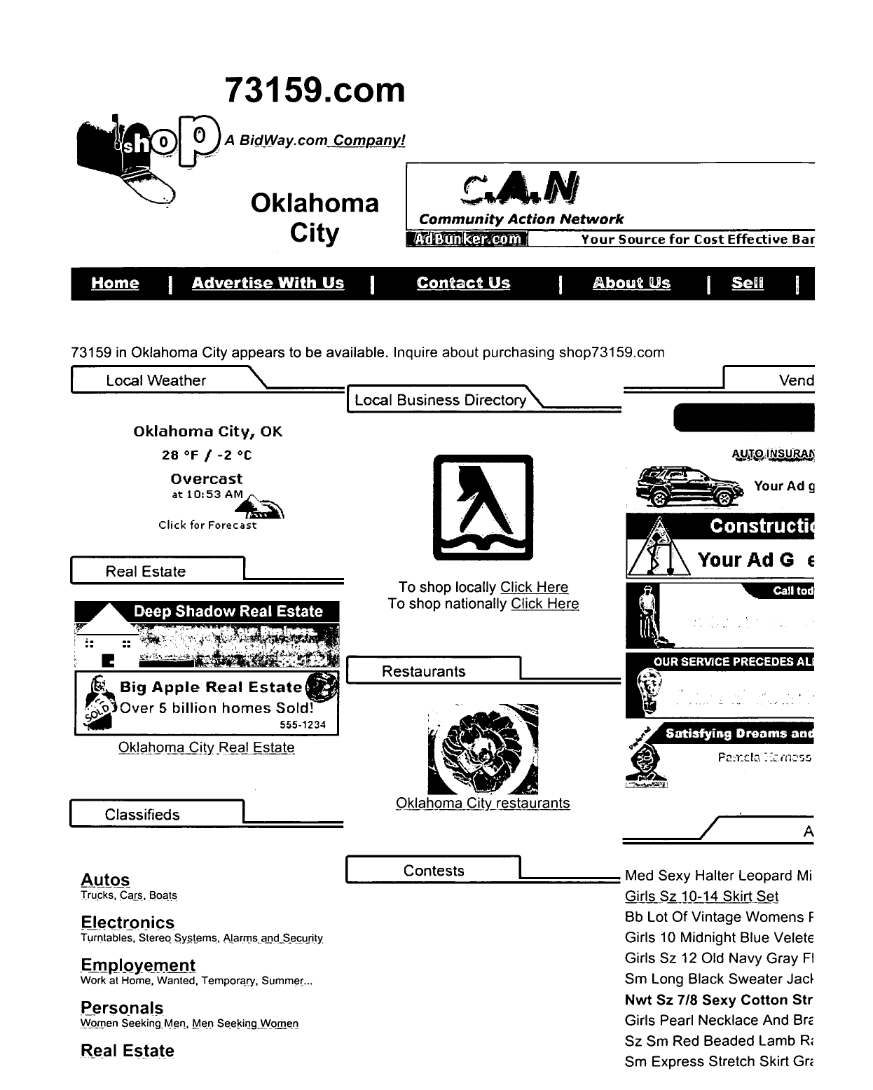

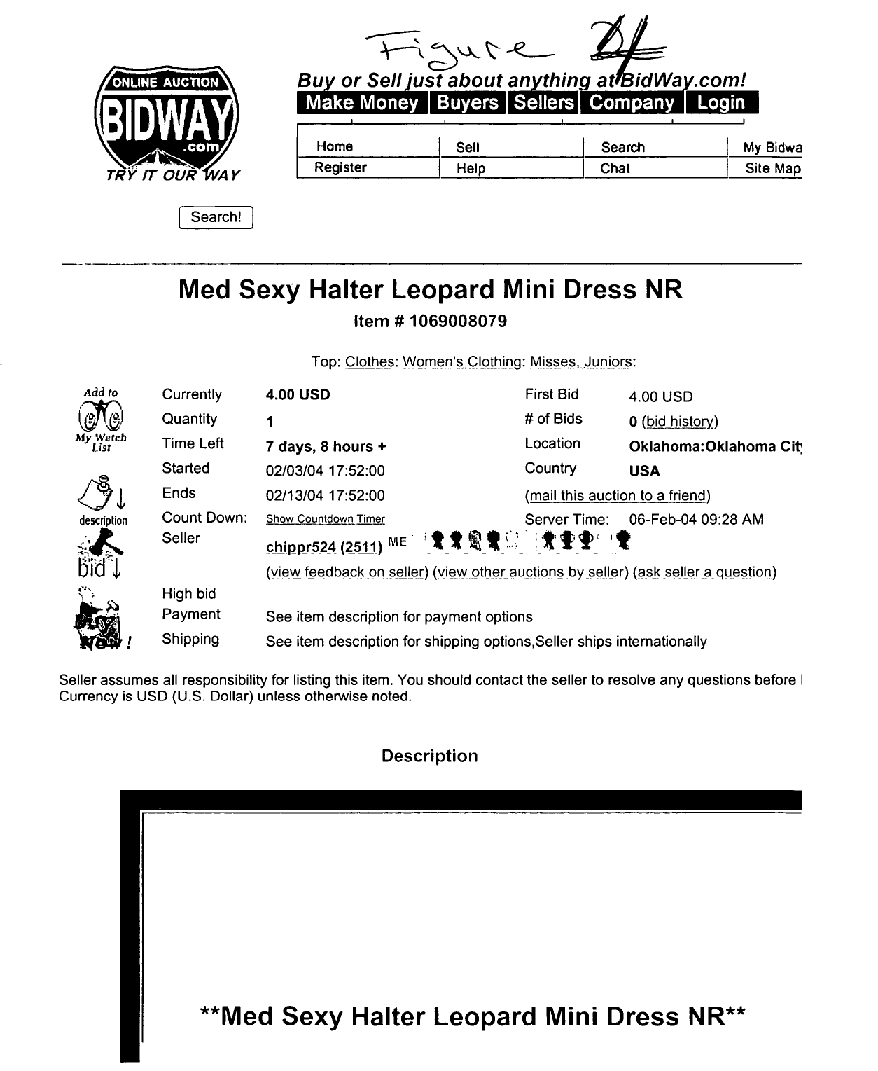

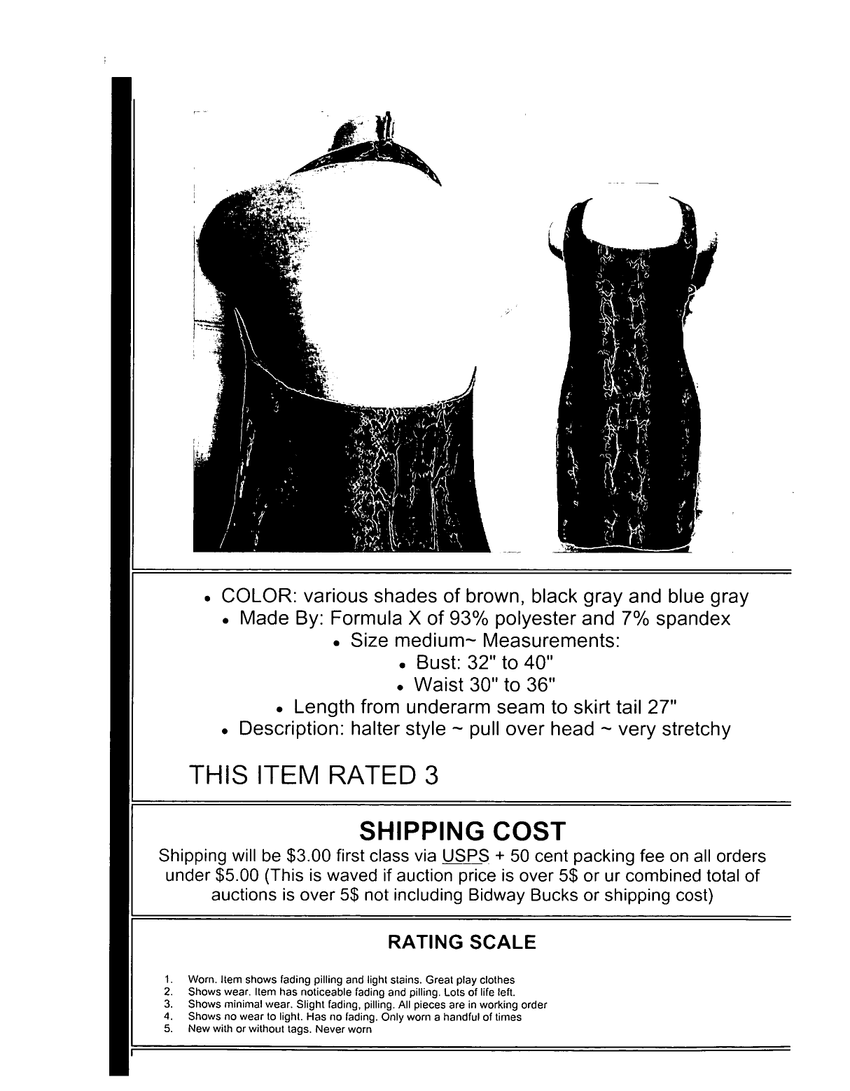

Turning third to FIG. 3 is a localized shop91042.com.

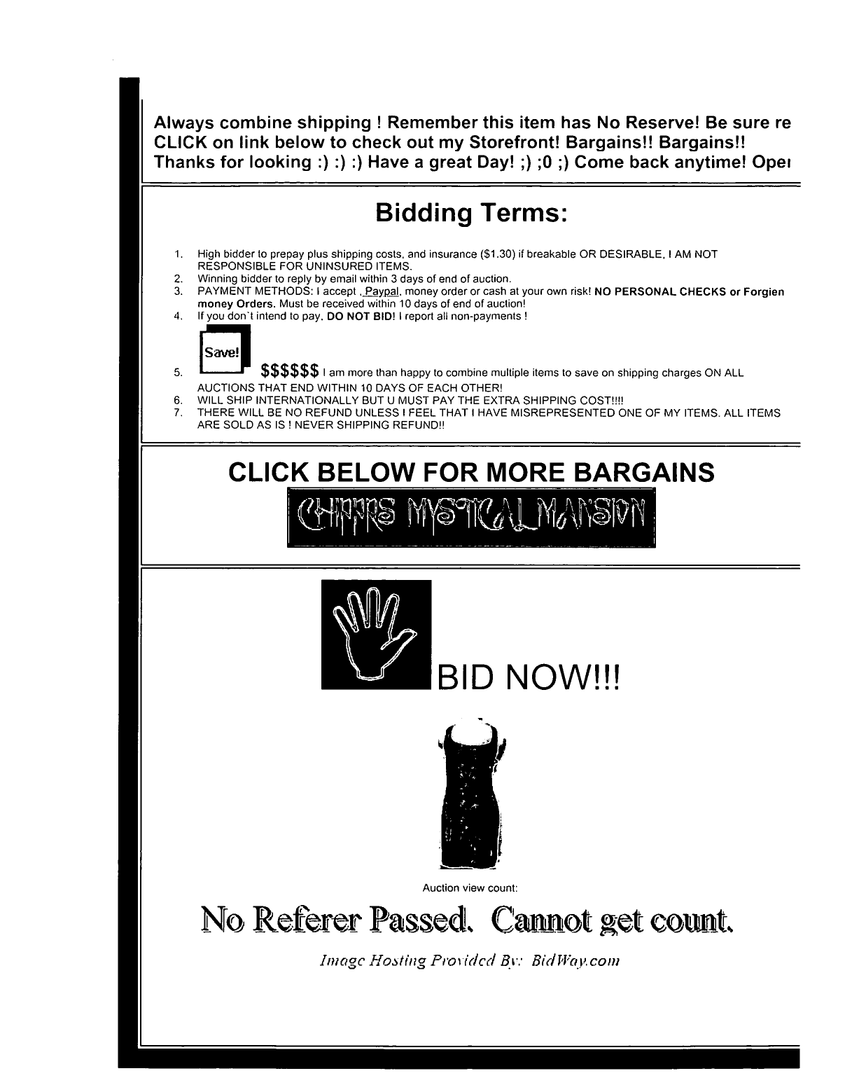

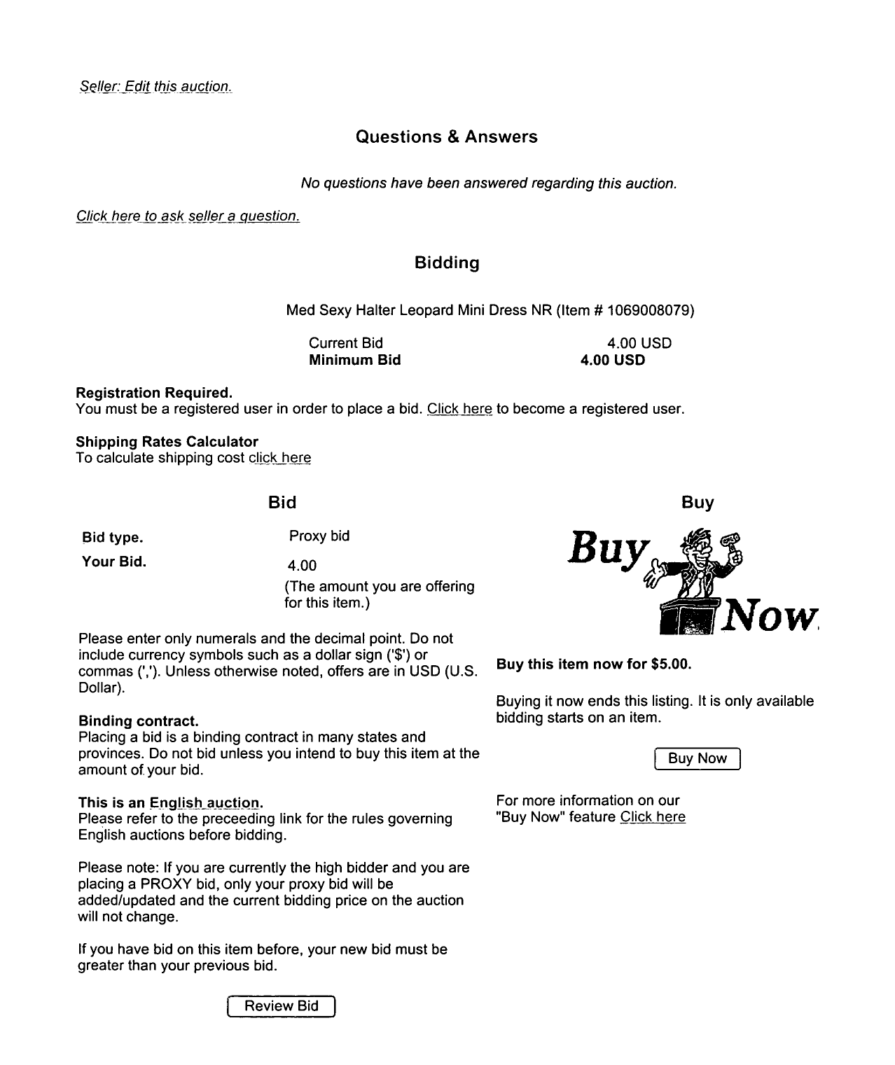

Turning fourth to FIG. 4 is the same running auction nationally and running concurently o the localized web site.

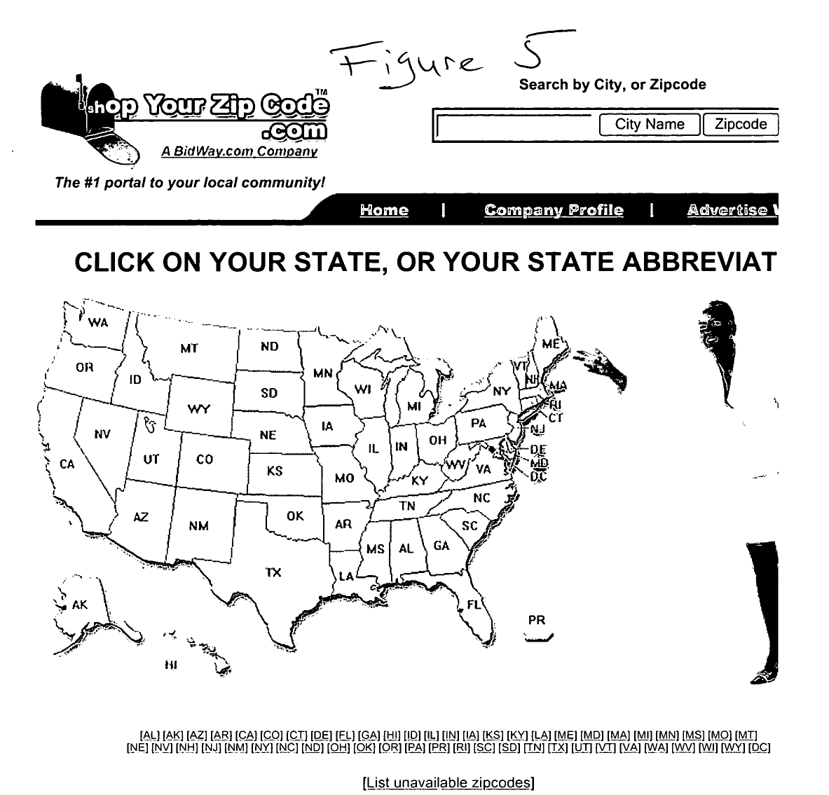

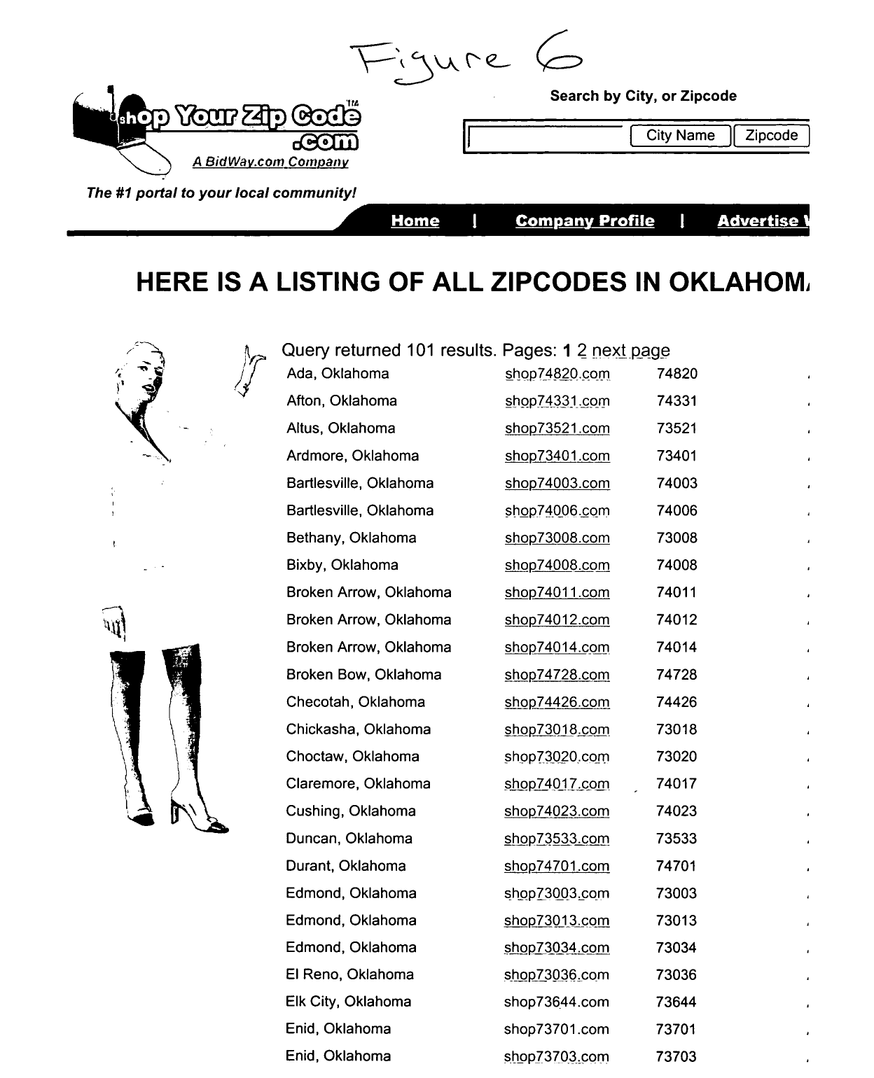

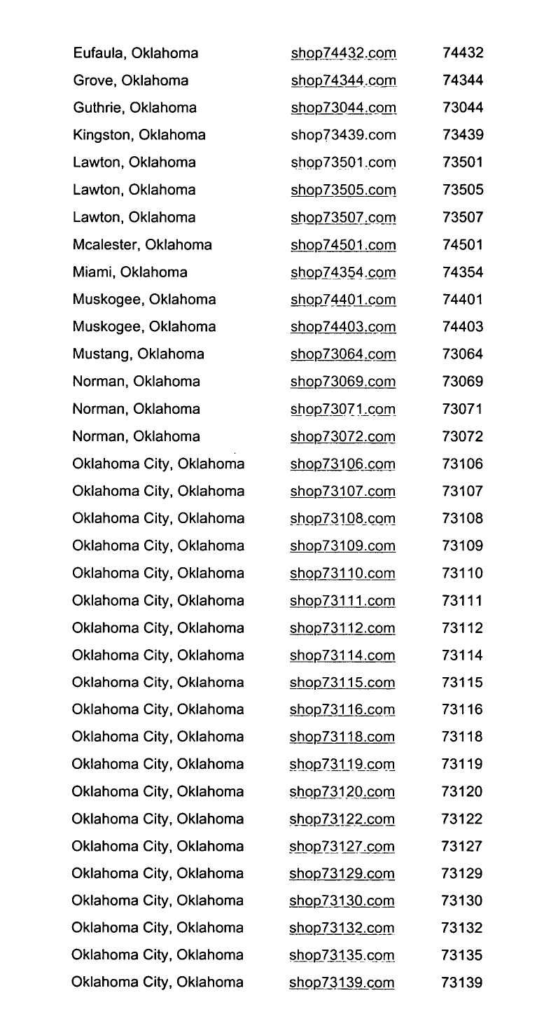

Turning fifth to FIG. 5 is the national business advertisers directories.

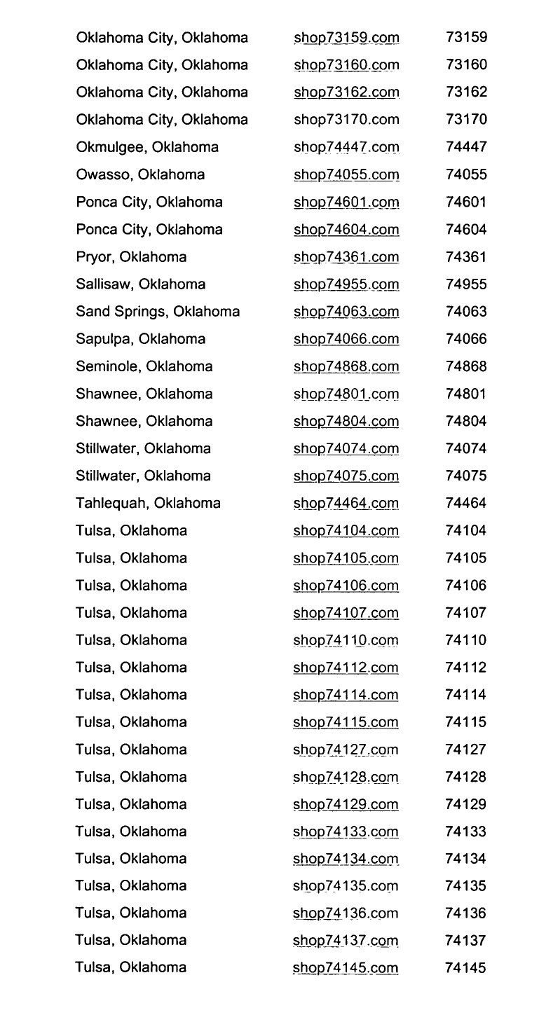

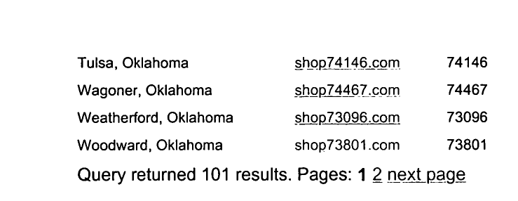

Turning sixth to FIG. 6 if a listing of all zip codes in one state.

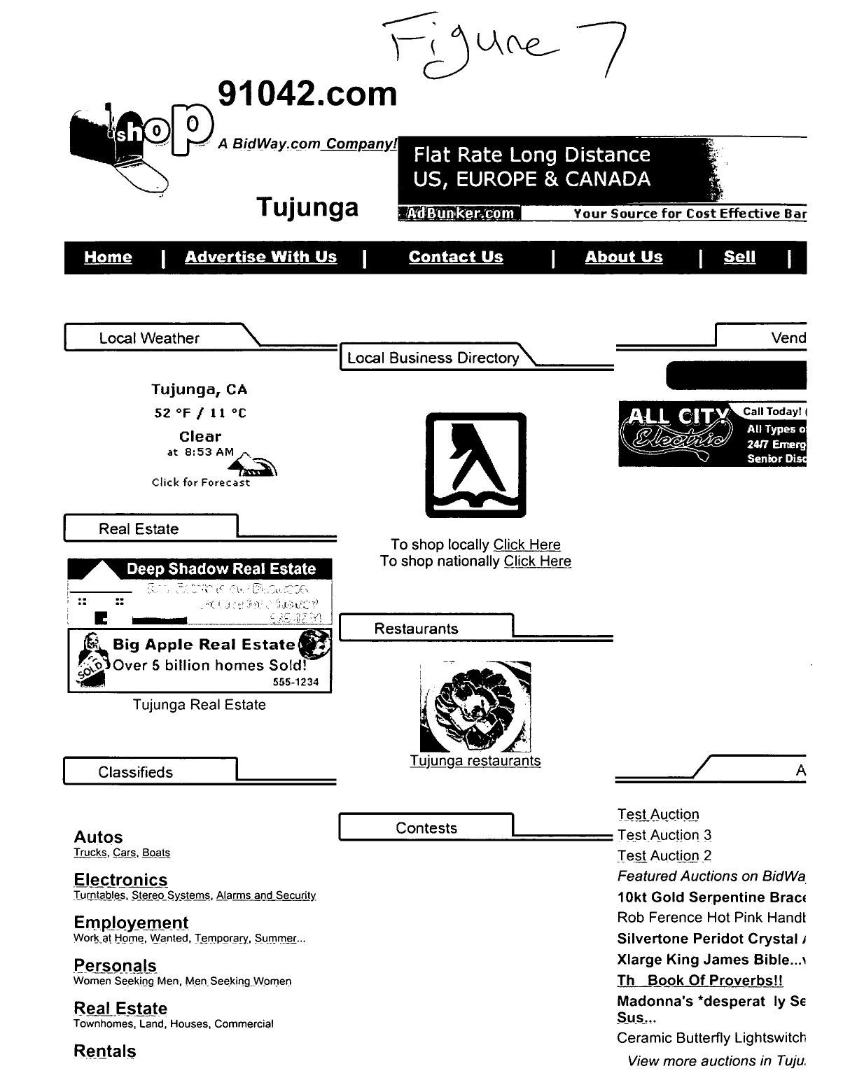

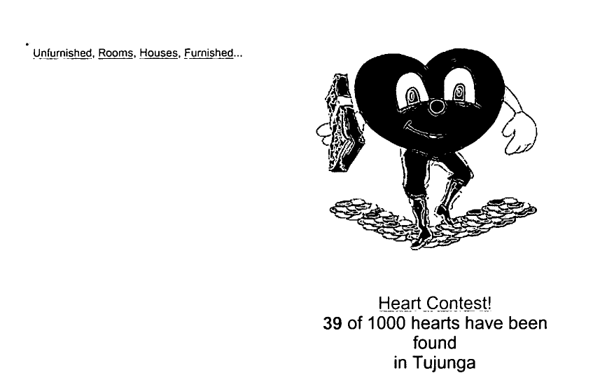

Turning seventh to FIG. 7 is a displayment of a localized business advertisers directory.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A process for localizing online auctions and local or national businesses by zipcodes. comprising the steps of:
Provide a national online auction site;
Provide a national business advertisements web site; and
Provide many localized, by zip codes, online web sites.

2. The method of claim 1 is to establish an online auction site. The online auction site will allow anyone over the age of eighteen to list items for auction via a bidding process or a buy now process.

3. The method in 2 is to further purchase many online web sites which are localized bu zip codes.

4. The method in 2 is to retrieve running auctions for 2 and import them to become live on the web within their localized zip code auction web sites.

5. The method in 4 could also allow members of the localized web sites to list auctions and will automatically run concurrently on the national web site.

6. The method of 1 is to allow local businesses to advertise their services in the local zip code web sites.

7. The localized web sites would have a search function incorporated in all of them that would search running auctions in any zip code web site ot localized business listed in their respective categories in any online localized web site.
